(19) United States
(12) Patent Application Publication
(10) Pub. No.: US 2025/0317194 A1
(43) Pub. Date: Oct. 9, 2025

(54) Wireless Installation of Physical SIM and eSIM Profiles on Airplane Systems

(71) Applicant: The Boeing Company, Arlington, VA (US)

(72) Inventors: Matthew S. Cornell, Lake Stevens, WA (US); Daniel John Ellis, Lexington, OH (US)

(21) Appl. No.: 19/056,215

(22) Filed: Feb. 18, 2025

Related U.S. Application Data
(60) Provisional application No. 63/575,069, filed on Apr. 5, 2024.

(51) Int. Cl. H04B 7/185; H04W 8/18

(52) U.S. Cl. CPC H04B 7/18506; H04W 8/18

(57) ABSTRACT

A cellular communication configuration system comprising a computer system and a configuration manager in the computer system. The configuration manager is configured to identify a profile for a mobile network that provides a cellular service. The configuration manager is configured to create a user modifiable software part for the mobile network using the profile, wherein the user modifiable software part is for a communications gateway in an aircraft that manages cellular communications. The configuration manager is configured to send the user modifiable software part to an aircraft network in the aircraft. The user modifiable software part is used to configure the communications gateway.

### CROSS-REFERENCE TO RELATED APPLICATION

This application claims the benefit of U.S. Provisional Patent Application Ser. No. 63/575,069, filed Apr. 5, 2024, and entitled “Wireless Installation of Physical SIM and eSIM Profiles on Airplane Systems,” which is incorporated herein by reference in its entirety.

### BACKGROUND INFORMATION

### 1. Field

The present disclosure relates generally to aircraft and in particular, to subscriber identifier module profiles used on aircraft.

### 2. Background

In the connected aircraft, airlines are increasingly leveraging real-time aircraft system data and real-time weather data to efficiently operate their fleets with applications on portable electronic flight bags (EFB). Electronic flight bags can take the form of tablet computers. Onboard connections can be provided to these devices by an aircraft interface device (AID). The aircraft interface device uses an offboard cellular connection to send data off board. With these connections, the aircraft interface device provides high-speed, high-bandwidth data communication between the computing devices on the aircraft with cellular and internet services.

### SUMMARY

An embodiment of the present disclosure provides a cellular communication configuration system comprising a computer system and a configuration manager in the computer system. The configuration manager is configured to identify a profile for a mobile network that provides a cellular service. The configuration manager is configured to create a user modifiable software part for the mobile network using the profile, wherein the user modifiable software part is for a communications gateway in an aircraft that manages cellular communications. The configuration manager is configured to send the user modifiable software part to an aircraft network in the aircraft. The user modifiable software part is used to configure the communications gateway.

Another embodiment of the present disclosure provides a communications configuration system comprising a computer system and a configuration manager in the computer system. The configuration manager is configured to identify a profile for a communications network that provides a communications service. The configuration manager is configured to create a user modifiable software part for the communications network using the profile. The user modifiable software part is for a communications gateway in an aircraft that manages communications with the aircraft. The configuration manager is configured to send the user modifiable software part to an aircraft network in the aircraft, wherein the user modifiable software part is used to configure the communications gateway.

Yet another embodiment of the present disclosure provides a method for configuring a communications gateway. A profile is identified for a communications network that provides a communications service. A user modifiable software part is created using the communications network. The user modifiable software part is for the communications gateway in an aircraft that manages communications with the aircraft. The user modifiable software part is sent to an aircraft network in the aircraft. The user modifiable software part is used to configure the communications gateway.

Still another embodiment of the present disclosure provides a computer program product for configuring a communications gateway. The computer program product comprises a set of one or more computer-readable storage media and program instructions, collectively stored in the set of one or more storage media, for causing a processor set to perform the following computer operations: identifying a profile for a mobile network that provides a cellular service; creating a user modifiable software part using the mobile network, wherein the user modifiable software part is for the communications gateway in an aircraft that manages cellular communications; and sending the user modifiable software part to an aircraft network in the aircraft, wherein the user modifiable software part is used to configure the communications gateway.

Another embodiment of the present disclosure provides a computer program product for configuring a communications gateway. The computer program product comprises a set of one or more computer-readable storage media and program instructions, collectively stored in the set of one or more storage media, for causing a processor set to perform the following computer operations program instructions, collectively stored in the set of one or more storage media, for causing a processor set to perform the following computer operations: identifying a profile for a communications network that provides a communications service; creating a user modifiable software part using the profile, wherein the user modifiable software part is for the communications gateway in an aircraft that manages communications with the aircraft; and sending the user modifiable software part to an aircraft network in the aircraft, wherein the user modifiable software part is used to configure the communications gateway.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a commercial airplane in which illustrative embodiments can be implemented;

FIG. 2 is an illustration of a block diagram of a communications environment in accordance with an illustrative embodiment;

FIG. 3 is an illustration of a block diagram of a profile in accordance with an illustrative embodiment;

FIG. 4 is an illustration of a dataflow diagram for configuring an aircraft using a profile located on a physical subscriber identity module (SIM) card in accordance with an illustrative embodiment;

FIG. 5 is an illustration of a flowchart of a process for configuring a communications gateway in accordance with an illustrative embodiment;

FIG. 6 is an illustration of a flowchart of a process for configuring a communications gateway in an aircraft in accordance with an illustrative embodiment;

FIG. 7 is an illustration of a flowchart of a process for configuring a communications gateway in an aircraft in accordance with an illustrative embodiment;

FIG. 8 is an illustration of a flowchart of a process for identifying a profile in accordance with an illustrative embodiment;

FIG. 9 is an illustration of a flowchart of a process for identifying a profile in accordance with an illustrative embodiment;

FIG. 10 is an illustration of a flowchart of a process for sending a user modifiable software part in accordance with an illustrative embodiment;

FIG. 11 is an illustration of a flowchart of a process for verifying a user modifiable software part in accordance with an illustrative environment; and

FIG. 12 is an illustration of a block diagram of a data processing system in accordance with an illustrative embodiment.

### DETAILED DESCRIPTION

The illustrative embodiments recognize and take into account one or more different considerations as described herein. Currently, an aircraft interface device uses a physical subscriber identity module (SIM) card to provide connectivity to communications networks. The SIM card contains a profile used to connect to a communications network such as a mobile communications network that provides cellular service. The service can be changed by changing the profile. Currently, this change is performed by removing and installing a new physical SIM card. This change can be made to provide different services or other features with respect to the cellular service. However, the aircraft interface device is not readily accessible from the cabin or cockpit of the aircraft. As a result, the time and effort needed to make changes to the aircraft interface device is more difficult than desired.

In one illustrative example, a cellular communication configuration system comprise a computer system and a configuration manager in the computer system. The configuration manager is configured to identify a profile for a mobile network that provides a cellular service. A mobile network is a type of communications network that enables mobile devices to connect to the internet, make calls, send messages, and use other services.

The configuration manager is configured to create a user modifiable software part for the mobile network using the profile, wherein the user modifiable software part is for a communications gateway in an aircraft that manages cellular communications. The configuration manager is configured to send the user modifiable software part to an aircraft network in the aircraft. The user modifiable software part is used to configure the communications gateway.

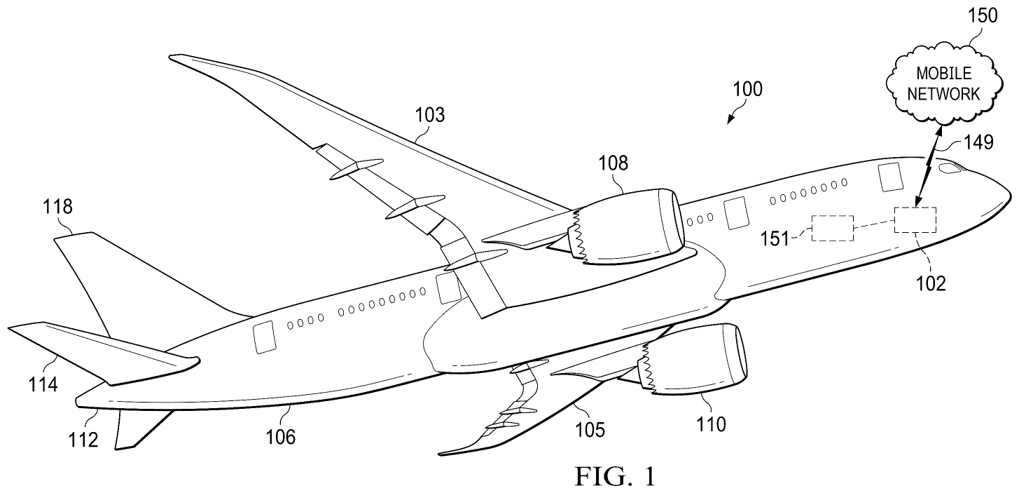

With reference now to the figures and, in particular, with reference to FIG. 1, a pictorial representation of a commercial airplane is depicted in which illustrative embodiments can be implemented. In this illustrative example, aircraft 100 has wing 103 and wing 105 attached to body 106. Commercial airplane 100 includes engine 108 attached to wing 103 and engine 110 attached to wing 105.

Body 106 has tail section 112. Horizontal stabilizer 114 and vertical stabilizer 118 are attached to tail section 112 of body 106. Another horizontal stabilizer is present but not seen in this view.

Commercial airplane 100 is an example of an aircraft in which communications gateway 102 can be implemented in accordance with an illustrative embodiment. In this illustrative example, communications gateway 102 is a device that manages a number of wireless connections 149 for commercial airplane 100. The management of wireless connections can include establishing a wireless connection, managing use of the wireless connection, and terminating the wireless connection. In this illustrative example, these wireless connections are to mobile networks 150.

In this example, communications gateway 102 is an aircraft interface device (AID) that can provide cellular service to commercial airplane 100. For example, communications gateway 102 can set up and manage wireless connections 149 to mobile network 150 in the form of a cellular mobile network to provide cellular service. Mobile network 150 can also include satellite services.

In these illustrative examples, communications gateway 102 can be configured using a user modifiable software (USP) part. This part can be created and uploaded wirelessly to an aircraft network 151 in commercial airplane 100. This aircraft network includes computers that can process a user modifiable software part and install this part in communications gateway 102. The aircraft network can be, for example, an onboard network system, a core network, an inflight entertainment network, a connected cargo network, or other suitable type of network or system that provides computing processes on commercial airplane 100. In these examples, the user modifiable software part has a design assurance level that is DAL E which does not require a human operator to be present on the aircraft to upload and install the user modifiable software (USP) part. DALE E is an assurance level in Design Assurance Level, developed by the Radio Technical Commission for Aeronautics (RTCA), in collaboration with the European Organization for Civil Aviation Equipment (EUROCAE), as part of standards for ensuring the safety of airborne systems and equipment.

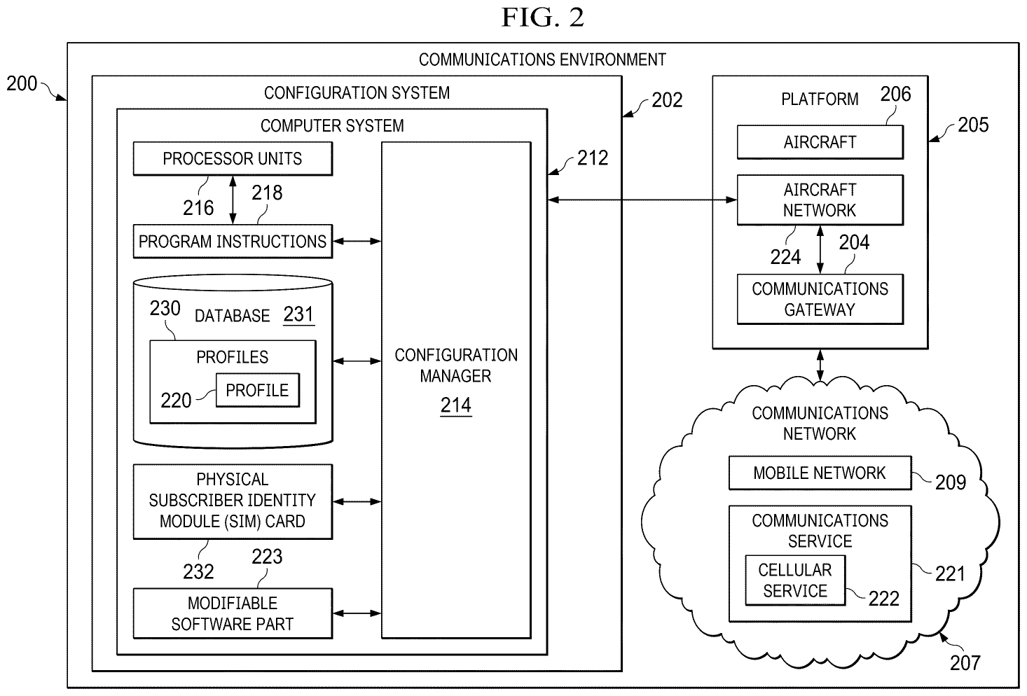

With reference now to FIG. 2, an illustration of a block diagram of a communications environment is depicted in accordance with an illustrative embodiment. Communications environment 200 is an environment in which configuration system 202 operates to configure communications gateway 204 in platform 205.

In this example, platform 205 is selected from a group comprising a mobile platform, a stationary platform, a land-based structure, an aquatic-based structure, a space-based structure, an aircraft, a surface ship, a tank, a personnel carrier, a train, a spacecraft, a space station, a satellite, a high altitude platform system (HAPS), a submarine, an automobile, a power plant, a bridge, a dam, a house, a manufacturing facility, and a building.

When platform 205 is aircraft 206, aircraft 206 can take a number of different forms. For example, aircraft 206 can be selected from a group comprising a commercial airplane, a cargo airplane, a rotor aircraft, a tilt wing aircraft, a vertical takeoff and landing aircraft, a rotorcraft, an unmanned aerial vehicle, a drone, an artificial intelligence controlled drone, an electric vertical takeoff and landing vehicle, a personal air vehicle, a glider, and other types of aircraft that can fly in the atmosphere. Commercial airplane 100 in FIG. 1 is an example of an implementation for aircraft 206.

In this illustrative example, communications gateway 204 is a hardware system that can also include software. For example, communications gateway 204 can be selected from a group comprising an aircraft interface device, a cellular modem, a satellite modem, an inflight entertainment server, and other suitable types of components.

Communications gateway 204 provides an interface between different communication systems in aircraft 206 and communications network 207. For example, communications gateway 204 manages communications with aircraft 206 such as communications between aircraft 206 and communications network 207.

In this example, communications network 207 can be at least one of a mobile network, a cellular network, a ground base network using very high frequency (VHF) signals, a satellite communications network, or other network for providing wireless communications with aircraft 206.

The phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Communications gateway 204 can be selected from a group comprising an aircraft interface device (AID), a cellular modem, a satellite modem, an inflight entertainment server, or other suitable type of gateway that can provide communications connections with communications network 207.

As depicted, configuration system 202 operates to manage the configuration of communications gateway 204. Configuration system 202 can configure communications gateway 204 to communicate with one or more networks in communications network 207.

For example, configuration system 202 can configure communications gateway 204 to establish communications connections with mobile network 209. In this example, mobile network 209 can be selected from a group comprising a 5G network, a Long-Term Evolution (LTE) network, a Universal Mobile Telecommunications System (UTMS) network, a Global System for Mobile Communications (GSM) network, and other suitable types of mobile networks. Further, the configuration can also include finding or enabling services accessed in mobile network 209.

In this illustrative example, configuration system 202 comprises computer system 212 and configuration manager 214. Configuration manager 214 is located in computer system 212.

Configuration manager 214 can be implemented in software, hardware, firmware or a combination thereof. When software is used, the operations performed by configuration manager 214 can be implemented in program instructions configured to run on hardware, such as a processor unit. When firmware is used, the operations performed by configuration manager 214 can be implemented in program instructions and data and stored in persistent memory to run on a processor unit. When hardware is employed, the hardware can include circuits that operate to perform the operations in configuration manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, configuration manager 214 performs a number of different operations to configure communications gateway 204. For example, configuration manager 214 identifies profile 220 for communications network 207 that provides communications service 221. Profile 220 can be identified from a block of profiles 230 in database 231. Connections to mobile network 209 can be set up and managed using one or more of profiles 230 that identify and provide information needed to connect to the communications network.

In this example, communications network 207 comprises or includes mobile network 209, and communications service 221 can be cellular service 222. With this example, configuration system 202 can be a cellular communications configuration system when used to configure communications gateway 204 to do cellular service 222 provided by mobile network 209.

Another example, profile 220 can be downloaded from another source such as a physical subscriber identity module (SIM) card 232.

Configuration manager 214 creates user modifiable software part 223 for communications network 207 using profile 220. In this example, user modifiable software part 223 is for communications gateway 204 in aircraft 206 that manages communications with aircraft 206. Configuration manager 214 sends user modifiable software part 223 to aircraft network 224 in aircraft 206. User modifiable software part 223 is used to configure communications gateway 204 in aircraft 206.

For example, user modifiable software part 223 can be securely sent to aircraft network 224 using an encrypted storage device. This secured storage device can be, for example, a universal serial bus (USB) drive or a secure digital card. Access points for these types of storage systems are more easily accessible as compared to replacing a physical subscriber identity module (SIM) card in the communications gateway 204.

For example, access to aircraft network 224 for these types of storage devices can be found in areas in aircraft 206 such as an avionics bag mount, the cockpit, maintenance panels, and in other locations that are accessible for maintenance.

In another example, user modifiable software part 223 can be sent to aircraft network 224 over a wireless connection to aircraft network 224. For example, a secured wireless connection can be used. A secured wireless connection can be provided through an electronic distribution system (EDS) for aircraft 206 in aircraft network 224. For example, user modifiable software part 223 can be sent over a wireless connection to aircraft 206 from a mobile computing device. In this example, configuration manager 214 can be located in the mobile computing device in computer system 212.

In this example, this loading of user modifiable software part 223 can occur using an aircraft data load network or other device that facilitates the verification and transfer of software parts to the appropriate component in aircraft 206. In this example, aircraft network 224 verifies authenticity and software integrity of user modifiable software part 223. This network sends user modifiable software part 223 to communications gateway 204 in response to user modifiable software part 223 being verified.

For example, software can be loaded onto communications gateway 204 by a data loader is compliant to various standards, such as ARINC 615 or ARINC 615A, which are standards developed by Aeronautical Radio, Inc. In this example, modifiable software part 223 has a design assurance level that is DAL E. This level is the lowest level of assurance and has no effect on the operational capability or safety of aircraft 206. In the illustrative example, this standard is defined by RTCA DO-178C, which is Software Considerations in Airborne Systems and Equipment Certification. This certification is a standard developed by the Radio Technical Commission for Aeronautics (RTCA) and European Organization for Civil Aviation Equipment (EUROCAE).

Thus, communications gateway 204 can be configured and reconfigured through the use of user modifiable software part 223. As different services, mobile networks, and other changes are needed for communications connections to communications network 207, new or modifiable software parts can be created and sent to communications gateway 204. As a result, physical access to communications gateway 204 is unnecessary to make updates to configure communications gateway 204 for different services in communications network 207.

In one illustrative example, one or more technical solutions are present that overcome a technical problem with establishing and managing connections to communications networks using a communications gateway for any platform such as an aircraft. As a result, one or more technical solutions may provide a technical effect reducing the time and effort needed to configure or reconfigure a communications gateway to connect to and provide services from one or more different networks in a communications network.

In the illustrative example, a communications gateway can be configured to connect to different networks in a communications network without having to physically access the communications gateway to configure the communications gateway. In other words, a human operator does not need to access a communications gateway to perform updates or change a physical subscriber identity module (SIM) card in the communications gateway.

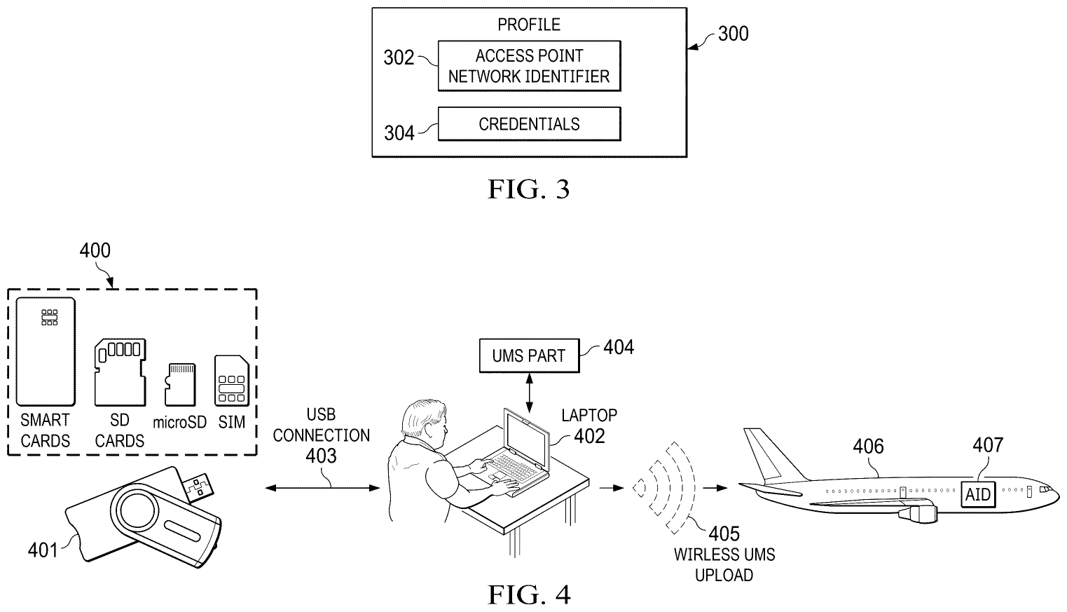

Turning next to FIG. 3, an illustration of a block diagram of a profile is depicted in accordance with an illustrative embodiment. In this example, profile 300 is an example of an implementation for profile 220 and other profiles in profiles 230 in FIG. 2.

As depicted, profile 300 comprises different types of information. In this example, profile 300 comprises access point network identifier 302 for a communications network and credentials 304 used to authenticate the communications network.

In this example, access point network identifier 302 is a unique identifier used in wireless networks to specify the gateway that connects devices to external networks, such as the internet or private data networks. Access point network identifier 302 can also include other information such as configuration settings needed for a connection to access specific services provided by the communications network.

Credentials 304 are used to verify the identity of the user and to obtain permission to connect to the communications network. For example, credentials 304 are used to authenticate a mobile network. In this example, credentials 304 can include at least one of a username, a password, a SIM card identifier, a security key, a pre-shared key (PSK), a digital certificate, biometric data, or other suitable information. In response to the authentication, aircraft network 224 can send user modifiable software part 223 to communications gateway 204.

The illustration of profile 300 is provided as one example and not meant to limit the manner in which profiles can be implemented. For example, profile 300 can also include other information such as configuration settings for services such as messaging, Internet access, quality of service parameters, network type, or other information.

In one illustrative example, profile 300 can be a subscriber identifier module (SIM) profile that comprises configuration data describing how to connect and interact with a mobile network. In this type profile, credentials 304 can include network within patient data such as encryption keys and algorithms to secure communications with the mobile network.

Other information in addition to access point network identifier 302 and credentials 304 can be present in profile 300. For example, service preference settings can also be included. The settings can include preferred network lists, roaming configurations, service access controls, and other data. This and other information can be present in profile 300 in addition to access point network identifier 302 and credentials 304.

The illustration of communications environment 200 and the different components in communications environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more platforms in addition to platform 205 can be managed by configuration manager 214 using user modifiable software parts such as, for example, other platforms for which communications can be configured to communicate with communications network 207. These other platforms can be of the same or different types of platforms from platform 205. For example, when platform 205 is aircraft 206, the other platforms can also be aircraft. In other examples, the other platforms can include at least one of buildings, satellites, manufacturing facilities, ships, trains, and other types of platforms.

In another example, user modifiable software part 223 is sent to a network for platform 205 such as a local area network for platform 205 in the form of a building, a controller area network (CAN) for platform 205 in the form of a vehicle, or some other suitable type of network.

With reference to FIG. 4, an illustration of a dataflow diagram for configuring an aircraft using a profile located on a physical subscriber identity module (SIM) card is depicted in accordance with an illustrative embodiment.

As depicted in this example, profiles can be located on physical SIM cards 400. The profiles on these physical SIM cards can be accessed using universal serial bus (USB) SIM reader 401. In this example, one of the physical SIM cards can be inserted into USB SIM reader 401 which can be connected to a device such as laptop 402 using USB connection 403.

With this connection, laptop 402 can access the user profile in a SIM card in SIM cards 400 inserted in USB SIM reader 401. This access can be performed by laptop 402 sending commands to Application Protocol Data Units (APDUs) in which commands and responses can be exchanged using these data units.

For example, command APDUs can be sent from laptop 402 to a SIM card inserted in USB SIM reader 401 to request specific data or actions. For example, actions can include instructions (select, read binary, verify PIN) and parameters (file identifier, data, PIN). The instructions specify an operation to be performed, while the parameters provide additional information used to perform the action in the instruction. Response APDUs are returned from the SIM card to laptop 402. The response APDUs can include status words indicating whether the action was a success or failure.

When the user profile is accessed, laptop 402 creates user modifiable software (UMS) part 404. This software part can be uploaded as part of a wireless user modifiable software (UMS) upload 405 to airplane 406.

This part is processed and installed on a communications gateway such as an aircraft interface device (AID) 407 in airplane 406. In this example, AID 407 stores the information in the software part into a nonvolatile memory. The storage of this data can be in a secure container with no other content. In other examples, this data can be stored in a trusted platform module (TPM). When stored in a trusted platform module, this data is stored in a protected chipset.

AID 407 can send this data to a cellular module for use in providing services. In this manner, changes can be made to provide different types of services or improve services as the services are available, become available, or are identified for use by airplane 406.

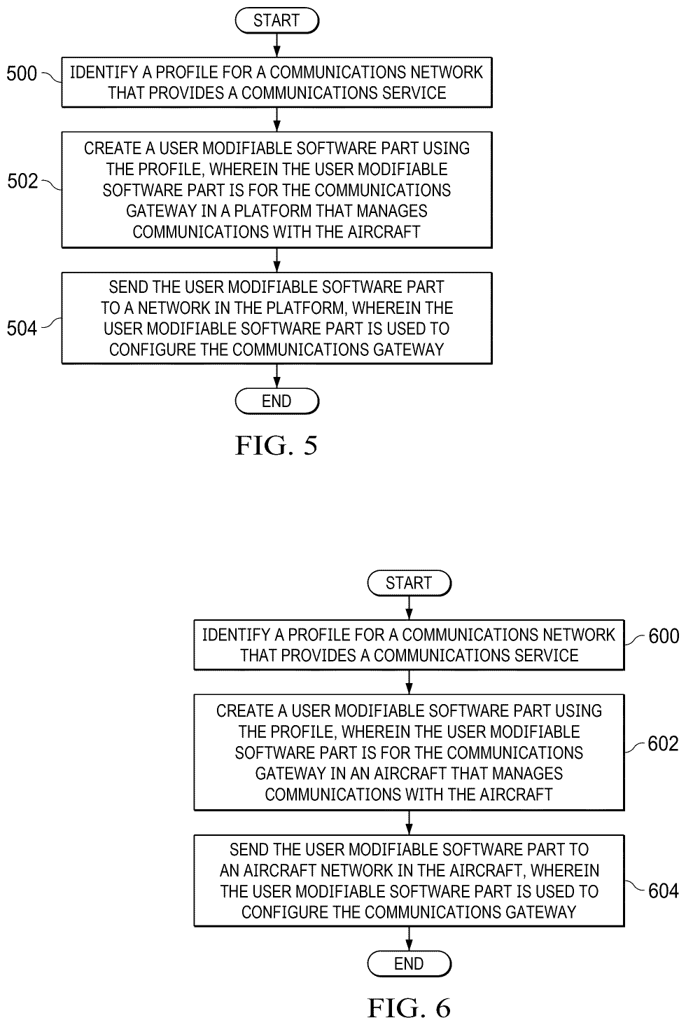

Turning next to FIG. 5, an illustration of a flowchart of a process for configuring a communications gateway is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in configuration manager 214 in computer system 212 in FIG. 2.

The process identifies a profile for a communications network that provides a communications service (operation 500). The process creates a user modifiable software part using the profile, wherein the user modifiable software part is for the communications gateway in a platform that manages communications with the aircraft (operation 502).

The process sends the user modifiable software part to a network in the platform, wherein the user modifiable software part is used to configure the communications gateway (operation 504). The process terminates thereafter.

Turning next to FIG. 6, an illustration of a flowchart of a process for configuring a communications gateway in an aircraft is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in configuration manager 214 in computer system 212 in FIG. 2.

The process identifies a profile for a communications network that provides a communications service (operation 600). In operation 600, the communications network can be selected from a group comprising a mobile network that provides cellular service and a satellite communications network. The communications gateway can be selected from a group comprising an aircraft interface device, a cellular modem, a satellite modem, an inflight entertainment server, and other suitable components that can be implemented as a gateway.

The process creates a user modifiable software part using the profile, wherein the user modifiable software part is for the communications gateway in an aircraft that manages communications with the aircraft (operation 602).

The process sends the user modifiable software part to an aircraft network in the aircraft, wherein the user modifiable software part is used to configure the communications gateway (operation 604). The process terminates thereafter.

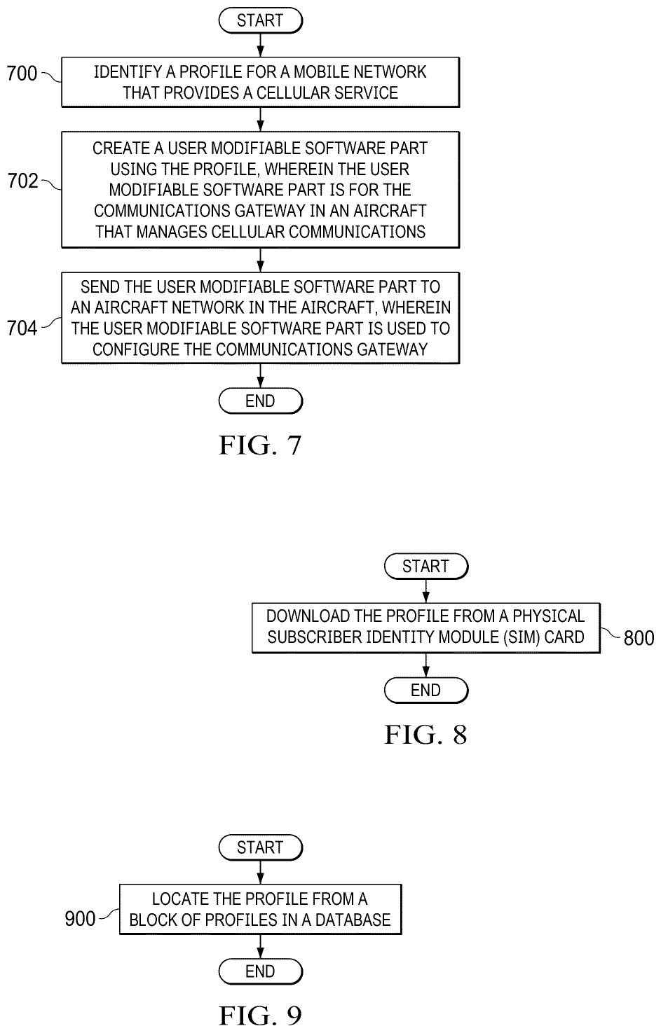

Turning to FIG. 7, an illustration of a flowchart of a process for configuring a communications gateway in an aircraft is depicted in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in configuration manager 214 in computer system 212 in FIG. 2.

The process identifies a profile for a mobile network that provides a cellular service (operation 700). The process creates a user modifiable software part using the profile, wherein the user modifiable software part is for the communications gateway in an aircraft that manages cellular communications (operation 702).

The process sends the user modifiable software part to an aircraft network in the aircraft, wherein the user modifiable software part is used to configure the communications gateway (operation 704). The process terminates thereafter.

With reference now to FIG. 8, an illustration of a flowchart of a process for identifying a profile is depicted in accordance with an illustrative embodiment. The process in this flowchart is an example of an implementation for operation 700 in FIG. 7.

The process downloads the profile from a physical subscriber identity module (SIM) card (operation 800). This process terminates thereafter.

Turning to FIG. 9, an illustration of a flowchart of a process for identifying a profile is depicted in accordance with an illustrative embodiment. The process in this flowchart is an example of an implementation for operation 700 in FIG. 7.

The process locates the profile from a block of profiles in a database (operation 900). The process terminates thereafter.

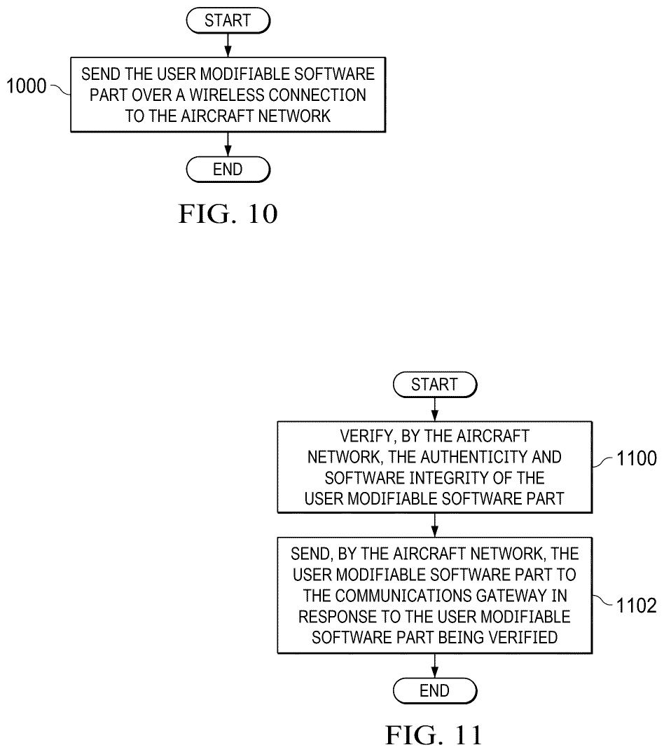

In FIG. 10, an illustration of a flowchart of a process for sending a user modifiable software part is depicted in accordance with an illustrative embodiment. The process in this flowchart is an example of an implementation for operation 704 in FIG. 7.

The process sends the user modifiable software part over a wireless connection to the aircraft network (operation 1000). The process terminates thereafter. In operation 1000, the user modifiable software part can be sent over the wireless connection to the aircraft network from a mobile computing device.

With reference now to FIG. 11, an illustration of a flowchart of a process for verifying a user modifiable software part is depicted in accordance with an illustrative environment. The operations in this flowchart are additional operations that can be performed with the operations in FIG. 7. In this example, the operations can be performed by aircraft network 224 in FIG. 2. In this example, the aircraft network can be selected from a group comprising an onboard network system and a core network.

The process verifies, by the aircraft network, the authenticity and software integrity of the user modifiable software part (operation 1100). The process sends, by the aircraft network, the user modifiable software part to the communications gateway in response to the user modifiable software part being verified (operation 1102). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

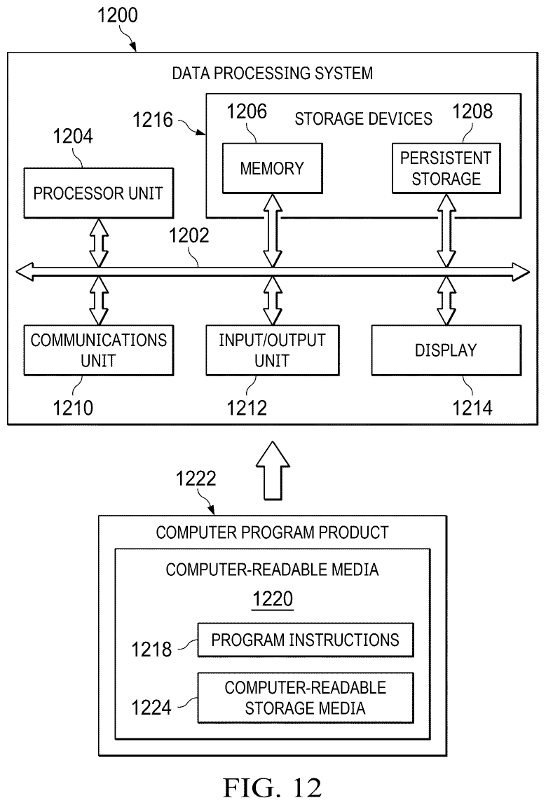

Turning now to FIG. 12, an illustration of a block diagram of a data processing system is depicted in accordance with an illustrative embodiment. Data processing system 1200 can be used to implement computing devices in aircraft network 151 and communications gateway 102 in FIG. 1, Data processing system 1200 can also be used to implement computer system 212, computing devices in aircraft network 224, and communications gateway 204 in FIG. 2. Further, data processing system 1200 can be used to implement laptop 402 and AID 407 in FIG. 3. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program instructions, computer usable program instructions, or computer-readable program instructions that can be read and executed by a processor in processor unit 1204. The program instructions in the different embodiments can be embodied on different physical or computer-readable storage media, such as memory 1206 or persistent storage 1208.

Program instructions 1218 are located in a functional form on computer-readable media 1220 that is selectively removable and can be loaded onto or transferred to data processing system 1200 for execution by processor unit 1204. Program instructions 1218 and computer-readable media 1220 form computer program product 1222 in these illustrative examples. In the illustrative example, computer-readable media 1220 is computer-readable storage media 1224.

Computer-readable storage media 1224 is a physical or tangible storage device used to store program instructions 1218 rather than a medium that propagates or transmits program instructions 1218. Computer-readable storage media 1224 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1224, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1218 can be transferred to data processing system 1200 using a computer-readable signal media. The computer-readable signal media are signals and can be, for example, a propagated data signal containing program instructions 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1220” can be singular or plural. For example, program instructions 1218 can be located in computer-readable media 1220 in the form of a single storage device or system. In another example, program instructions 1218 can be located in computer-readable media 1220 that is distributed in multiple data processing systems. In other words, some instructions in program instructions 1218 can be located in one data processing system while other instructions in program instructions 1218 can be located in one data processing system. For example, a portion of program instructions 1218 can be located in computer-readable media 1220 in a server computer while another portion of program instructions 1218 can be located in computer-readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of, another component. For example, memory 1206, or portions thereof, may be incorporated in processor unit 1204 in some illustrative examples. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program instructions 1218.

Thus, the illustrative examples provide a method, apparatus, system, and computer program product for configuring mutations gateways and platforms such as aircraft. In one illustrative example, a cellular communication configuration system comprising a computer system and a configuration manager in the computer system. The configuration manager is configured to identify a profile for a mobile network that provides a cellular service. The configuration manager is configured to create a user modifiable software part for the mobile network using the profile, wherein the user modifiable software part is for a communications gateway in an aircraft that manages cellular communications. The configuration manager is configured to send the user modifiable software part to an aircraft network in the aircraft. The user modifiable software part is used to configure the communications gateway.

As a result, communications gateways in hard-to-reach locations in different platforms such as aircraft can be more quickly and easily configured or reconfigured. In these different examples, the reconfiguration can enable accessing or using new or additional services from different communications networks with less effort and time as compared to current techniques for reconfiguration such as an aircraft. In the different illustrative examples, access to the communications gateway is unnecessary because the information needed to reconfigured the communications gateway is sent to a platform such as aircraft in the form of a modifiable software part. Within aircraft, the aircraft network receives as part, processes depart, and then sends the park to the communications gaping for use in any configuration reconfiguration to access the communications network.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A cellular communication configuration system comprising:
a computer system; and
a configuration manager in the computer system, wherein the configuration manager is configured to:
identify a profile for a mobile network that provides a cellular service;
create a user modifiable software part for the mobile network using the profile, wherein the user modifiable software part is for a communications gateway in an aircraft that manages cellular communications; and
send the user modifiable software part to an aircraft network in the aircraft, wherein the user modifiable software part is used to configure the communications gateway.

2. The cellular communication configuration system of claim 1, wherein in identifying the profile for the mobile network that provides the cellular service, the configuration manager is configured to:
download the profile from a physical subscriber identity module (SIM) card.

3. The cellular communication configuration system of claim 1, wherein in identifying the profile for the mobile network that provides the cellular service, the configuration manager is configured to:
locate the profile from a block of profiles in a database.

4. The cellular communication configuration system of claim 1, wherein in sending the user modifiable software part to the aircraft network in the aircraft, the configuration manager is configured to:
send the user modifiable software part over a wireless connection to the aircraft network.

5. The cellular communication configuration system of claim 4, wherein the user modifiable software part is sent over the wireless connection to the aircraft network from a mobile computing device.

6. The cellular communication configuration system of claim 1, wherein the aircraft network verifies authenticity and software integrity of the user modifiable software part and sends the user modifiable software part to the communications gateway in response to the user modifiable software part being verified.

7. The cellular communication configuration system of claim 1, wherein the profile comprises an access point network identifier for the mobile network and credentials to authenticate the mobile network, wherein the aircraft network sends the user modifiable software part to the communications gateway.

8. The cellular communication configuration system of claim 1, wherein the computer system is selected from at least one of a laptop computer, an electronic flight bag, a tablet computer, or a mobile phone.

9. The cellular communication configuration system of claim 1, wherein the aircraft network is selected from a group comprising an onboard network system, a core network, an inflight entertainment network, and a connected cargo network.

10. The cellular communication configuration system of claim 1, wherein the user modifiable software part has a design assurance level that is DAL E.

11. The cellular communication configuration system of claim 1, wherein the communications gateway is selected from a group comprising an aircraft interface device, a cellular modem, a satellite modem, and an inflight entertainment server.

12. The cellular communication configuration system of claim 1, wherein the mobile network is selected from a group comprising a 5G network, a Long-Term Evolution (LTE) network, a Universal Mobile Telecommunications System (UTMS) network, and a Global System for Mobile Communications (GSM) network.

13. The cellular communication configuration system of claim 1, wherein the communications gateway manages connections with the mobile network and a satellite communications network.

14. A communications configuration system comprising:
a computer system; and
a configuration manager in the computer system, wherein the configuration manager is configured to:
identify a profile for a communications network that provides a communications service;
create a user modifiable software part for the communications network using the profile, wherein the user modifiable software part is for a communications gateway in an aircraft that manages communications with the aircraft; and
send the user modifiable software part to an aircraft network in the aircraft, wherein the user modifiable software part is used to configure the communications gateway.

15. The communications configuration system of claim 14, wherein the communications gateway is selected from a group comprising an aircraft interface device, a cellular modem, a satellite modem, and an inflight entertainment server.

16. The communication configuration system of claim 14, wherein the communications network is selected from a group comprising a mobile network that provides cellular service and a satellite communications network.

17. A method for configuring a communications gateway, the method comprising:
identifying a profile for a mobile network that provides a cellular service;
creating a user modifiable software part using the profile, wherein the user modifiable software part is for the communications gateway in an aircraft that manages cellular communications; and
sending the user modifiable software part to an aircraft network in the aircraft, wherein the user modifiable software part is used to configure the communications gateway.

18. The method of claim 17, wherein identifying the profile comprises:
downloading the profile from a physical subscriber identity module (SIM) card.

19. The method of claim 17, wherein identifying the profile comprises:
locating the profile from a block of profiles in a database.

20. The method of claim 17, wherein sending the user modifiable software part comprises:
sending the user modifiable software part over a wireless connection to the aircraft network.

21. The method of claim 20, wherein the user modifiable software part is sent over the wireless connection to the aircraft network from a mobile computing device.

22. The method of claim 20, further comprising:
verifying, by the aircraft network, authenticity and software integrity of the user modifiable software part; and
sending, by the aircraft network, the user modifiable software part to the communications gateway in response to the user modifiable software part being verified.

23. The method of claim 17, wherein the profile comprises an access point network identifier for the mobile network and credentials to authenticate to the mobile network, wherein the aircraft network sends the user modifiable software part to the communications gateway.

24. The method of claim 17, wherein the aircraft network is selected from a group comprising an onboard network system and a core network.

25. The method of claim 17, wherein the user modifiable software part has a design assurance level that is DAL E.

26. The method of claim 17, wherein the mobile network is selected from a group comprising a 5G network, a Long-Term Evolution (LTE) network, a Universal Mobile Telecommunications System (UTMS) network, and a Global System for Mobile Communications (GSM) network.

27. The method of claim 17, wherein the communications gateway manages connections with the mobile network and a satellite communications network.

28. A method for configuring a communications gateway, the method comprising:
identifying a profile for a communications network that provides a communications service;
creating a user modifiable software part using the profile, wherein the user modifiable software part is for the communications gateway in an aircraft that manages communications with the aircraft; and
sending the user modifiable software part to an aircraft network in the aircraft, wherein the user modifiable software part is used to configure the communications gateway.

29. The method of claim 28, wherein the communications network is selected from a group comprising a mobile network that provides cellular service and a satellite communications network.

30. The method of claim 28, wherein the communications gateway is selected from a group comprising an aircraft interface device, a cellular modem, a satellite modem, and an inflight entertainment server.

31. A computer program product for configuring a communications gateway, the computer program product comprising:
a set of one or more computer-readable storage media; and
program instructions, collectively stored in the set of one or more storage media, for causing a processor set to perform the following computer operations:
identifying a profile for a mobile network that provides a cellular service;
creating a user modifiable software part using the profile, wherein the user modifiable software part is for the communications gateway in an aircraft that manages cellular communications; and
sending the user modifiable software part to an aircraft network in the aircraft, wherein the user modifiable software part is used to configure the communications gateway.

32. A computer program product for configuring a communications gateway, the computer program product comprising:
a set of one or more computer-readable storage media; and
program instructions, collectively stored in the set of one or more storage media, for causing a processor set to perform the following computer operations:
identifying a profile for a communications network that provides a communications service;
creating a user modifiable software part using the profile for communications network, wherein the user modifiable software part is for the communications gateway in an aircraft that manages communications with the aircraft; and
sending the user modifiable software part to an aircraft network in the aircraft, wherein the user modifiable software part is used to configure the communications gateway.
